(19) United States
(12) Patent Application Publication
(10) Pub. No.: US 2023/0128076 A1
(43) Pub. Date: Apr. 27, 2023

(54) BRAKE FOR VEHICLE AND VEHICLE

(71) Applicant: NIO TECHNOLOGY (ANHUI) CO., LTD, Hefei City (CN)

(72) Inventors: Rui WANG, Shanghai (CN); Yiming MA, Shanghai (CN); Yongxiang SHI, Shanghai (CN)

(21) Appl. No.: 18/049,078

(22) Filed: Oct. 24, 2022

(30) Foreign Application Priority Data
Oct. 27, 2021 (CN) 202122597707.3

(51) Int. Cl. F16D 65/00

(52) U.S. Cl. CPC F16D 65/0012; F16D 65/0075; F16D 2055/002

(57) ABSTRACT

The disclosure relates to the technical field of vehicle accessories, and particularly provides a brake for a vehicle and a vehicle. The disclosure aims at solving the problem that existing brakes for a vehicle usually cannot overcome low-frequency stubborn noise generated by a caliper structure in the brake in a braking process. For this purpose, the brake for a vehicle according to the disclosure comprises a first caliper body and a second caliper body, wherein the first caliper body and the second caliper body are provided with a first friction disc and a second friction disc respectively, a brake disc is arranged between the first friction disc and the second friction disc, and the first friction disc and the second friction disc are each further provided with at least one mass block, so as to quickly reduce low-frequency operating noise of the brake, thereby fundamentally eliminating braking noise, and then solving the problem that the existing brakes for a vehicle usually cannot overcome low-frequency stubborn noise generated by a caliper structure in the brake in a braking process.

### CROSS-REFERENCE TO RELATED APPLICATION

This application claims the benefit of China Patent Application No. 202122597707.3 filed Oct. 27, 2021, the entire contents of which are incorporated herein by reference in its entirety.

### TECHNICAL FIELD

The disclosure relates to the technical field of vehicle accessories, and particularly provides a brake for a vehicle and a vehicle.

### BACKGROUND

With the development of the vehicle industry, consumers have increasingly higher requirements for the safety performance of vehicles, and the performance of a brake as an important safety device is particularly important.

In a vehicle braking process, friction between a friction disc and a brake disc generates noise. Existing brakes for a vehicle usually reduce the noise by means of adjusting material of a brake pad shim, adjusting material of the friction disc, slotting or chamfering the friction disc and improving pressure distribution of the friction disc.

However, the problem exists that the existing brakes for a vehicle usually cannot overcome low-frequency stubborn noise generated by a caliper structure in the brake in a braking process by reducing the noise using the foregoing methods.

Accordingly, there is a need in the art for a new brake for a vehicle and a vehicle to solve the foregoing problem.

### BRIEF SUMMARY

To solve the foregoing problem in the prior art, that is, to solve the problem that existing brakes for a vehicle usually cannot overcome low-frequency stubborn noise generated by a caliper structure in the brake in a braking process, the disclosure provides a brake for a vehicle, comprising a first caliper body and a second caliper body, wherein the first caliper body and the second caliper body are provided with a first friction disc and a second friction disc respectively, a brake disc is arranged between the first friction disc and the second friction disc, and the first friction disc and the second friction disc are each further provided with at least one mass block.

In a preferred technical solution of the brake for a vehicle, a natural frequency corresponding to the at least one mass block matches a frequency of noise generated by the first friction disc, the second friction disc and the brake disc in a braking process.

In a preferred technical solution of the brake for a vehicle, the first friction disc is provided with a first mass block and a second mass block, the second friction disc is provided with a third mass block and a fourth mass block, the first mass block and the second mass block are respectively arranged at two ends of the first friction disc in a first direction, and the third mass block and the fourth mass block are respectively arranged at two ends of the second friction disc in the first direction.

In a preferred technical solution of the brake for a vehicle, the first mass block and the second mass block are separately riveted or bolted or welded to the first friction disc, and the third mass block and the fourth mass block are separately riveted or bolted or welded to the second friction disc.

In a preferred technical solution of the brake for a vehicle, the brake further comprises an active return device, wherein the active return device comprises a fixedly-arranged active return device body and two return springs symmetrically attached on the active return device body, and two ends of each of the two return springs abut against the first friction disc and the second friction disc respectively.

In a preferred technical solution of the brake for a vehicle, the return springs each comprises a return beam and two resilient pieces symmetrically arranged on two sides of the return beam, and the return beam is fixedly connected to the active return device body.

In a preferred technical solution of the brake for a vehicle, the resilient pieces each comprises a first bent portion, a second bent portion and a third bent portion which are connected in sequence, the first bent portion is connected to the return beam, and the third bent portion abuts against the first friction disc or the second friction disc.

In a preferred technical solution of the brake for a vehicle, an arc-shaped bend is further arranged between the return beam and each resilient piece, and the return spring is detachably connected to the active return device body. In a preferred technical solution of the brake for a vehicle, the return spring is detachably connected to the active return device body.

In a preferred technical solution of the brake for a vehicle, the active return device body is further provided with a bridge-shaped structure, and the bridge-shaped structure is fixedly connected to the active return device body.

The disclosure further provides a vehicle. The vehicle comprises a brake for a vehicle according to any one of the foregoing technical solutions.

It can be understood by those skilled in the art that, in the technical solutions of the disclosure, the brake comprises a first caliper body and a second caliper body, wherein the first caliper body and the second caliper body are provided with a first friction disc and a second friction disc respectively, a brake disc is arranged between the first friction disc and the second friction disc, and the first friction disc and the second friction disc are each further provided with at least one mass block.

Through the foregoing arrangement, in the brake for a vehicle according to the disclosure, the first friction disc and the second friction disc are each provided with at least one mass block, and natural frequencies of the first friction disc and the second friction disc each provided with the at least one mass block are adjusted by tuning properties such as mass, density and volume of the at least one mass block 3, so that there is a relatively large difference between the natural frequencies of the first friction disc and the second friction disc each provided with the mass blocks and a frequency of low-frequency noise, so as to quickly reduce low-frequency operating noise of the brake, thereby fundamentally eliminating braking noise, and then solving the problem that existing brakes for a vehicle usually cannot overcome low-frequency stubborn noise generated by a caliper structure in the brake in a braking process. In addition, the brake according to the disclosure further improves the comfort level of driving experience of a user, and solves the problem in the prior art that a development cycle is prolonged due to modification of a caliper structure and a mold during reduction of braking noise.

### BRIEF DESCRIPTION OF THE SEVERAL VIEWS OF THE DRAWINGS

A brake for a vehicle and a vehicle according to the disclosure are described below with reference to accompanying drawings. In the accompanying drawings:

FIG. 1 is a schematic diagram of a three-dimensional structure of a brake for a vehicle according to the disclosure;

FIG. 2 is a schematic diagram of a planar structure of a brake for a vehicle according to the disclosure; and

FIG. 3 is a schematic structural diagram of assembly of mass blocks, a first friction disc and a second friction disc of a brake for a vehicle according to the disclosure.

### LIST OF REFERENCE NUMERALS

1—First caliper body; 11—First friction disc;
2—Second caliper body; 21—Second friction disc;
3—Mass block; 31—First mass block; 32—Second mass block; 33—Third mass block; 34—Fourth mass block;
4—Active return device; 41—Active return device body; 411—Bridge-shaped structure; 42—Return spring; 421—Return beam; 422—Resilient piece; 4221—First bent portion; 4222—Second bent portion; 4223—Third bent portion; and 423—Arc-shaped bend.

### DETAILED DESCRIPTION

Preferred implementations of the disclosure are described below with reference to the accompanying drawings. It should be understood by those skilled in the art that these implementations are only for explaining the technical principles of the disclosure and are not intended to limit the scope of protection of the disclosure. Those skilled in the art can make adjustments according to requirements so as to adapt to specific application scenarios. For example, although in the specification, a connection relationship between a first mass block and a second mass block and a first friction disc and a connection relationship between a third mass block and a fourth mass block and a second friction disc are described by taking separate riveting of the first mass block and the second mass block to the first friction disc and separate riveting of the third mass block and the fourth mass block to the second friction disc, the connection relationship between the first mass block and the second mass block and the first friction disc and the connection relationship between the third mass block and the fourth mass block and the second friction disc according to the disclosure are not limited thereto, provided that the connection relationships can meet assembly requirements that the first mass block and the second mass block are fixedly installed on the first friction disc and that the third mass block and the fourth mass block are fixedly installed on the second friction disc. For example, the first mass block and the second mass block are separately bolted to the first friction disc, and the third mass block and the fourth mass block are separately bolted to the second friction disc. For another example, the first mass block and the second mass block are separately welded to the first friction disc, and the third mass block and the fourth mass block are separately welded to the second friction disc.

It should be noted that, in the description of the disclosure, the terms “first,” “second,” “third” and “fourth” are merely used for description but cannot be understood as indicating or implying relative importance.

In addition, it should also be noted that, in the description of the disclosure, the term “connect” should be interpreted in a broad sense unless explicitly defined and limited otherwise. For example, a connection may be a fixed connection, a detachable connection, or an integral connection; or may be a direct connection, or an indirect connection through an intermediate medium. For those skilled in the art, the specific meanings of the foregoing terms in the disclosure can be interpreted according to a specific situation.

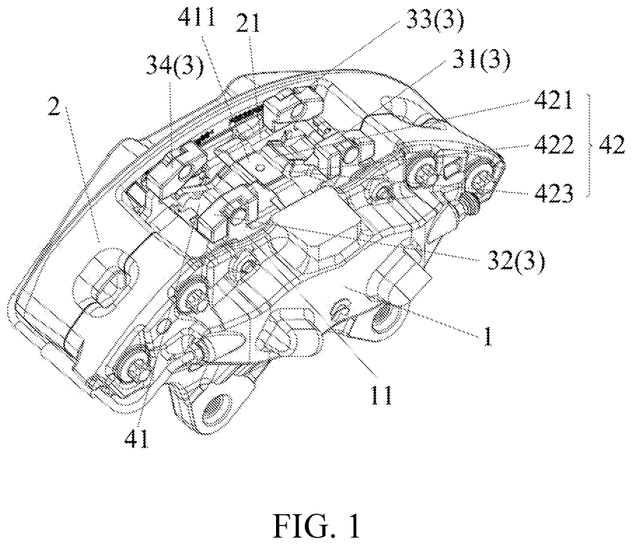

Referring to FIG. 1, a brake for a vehicle according to the disclosure is described first. FIG. 1 is a schematic diagram of a three-dimensional structure of a brake for a vehicle according to the disclosure.

As shown in FIG. 1, to solve the problem that existing brakes for a vehicle usually cannot overcome low-frequency stubborn noise generated by a caliper structure in the brake in a braking process, a brake for a vehicle according to the disclosure comprises a first caliper body 1 and a second caliper body 2, wherein the first caliper body 1 and the second caliper body 2 are provided with a first friction disc 11 and a second friction disc 21 respectively, a brake disc is arranged between the first friction disc 11 and the second friction disc 21, and the first friction disc 11 and the second friction disc 21 are each further provided with at least one mass block 3.

Through the foregoing arrangement, in the brake for a vehicle according to the disclosure, the first friction disc 11 and the second friction disc 21 are each provided with the at least one mass block 3, and natural frequencies of the first friction disc 11 and the second friction disc 21 each provided with the at least one mass block 3 are adjusted by tuning properties such as mass, density and volume of the at least one mass block 3, so that there is a relatively large difference between the natural frequencies of the first friction disc 11 and the second friction disc 21 each provided with the at least one mass block 3 and a frequency of low-frequency noise, so as to quickly reduce low-frequency operating noise of the brake, thereby fundamentally eliminating braking noise, and then solving the problem that existing brakes for a vehicle usually cannot overcome low-frequency stubborn noise generated by a caliper structure in the brake in a braking process. In addition, the brake according to the disclosure further improves the comfort level of driving experience of a user, and solves the problem in the prior art that a development cycle is prolonged due to modification of a caliper structure and a mold during reduction of braking noise.

Further referring to FIGS. 1 to 3, a brake for a vehicle according to the disclosure is described in detail below.

As shown in FIG. 1, in a possible implementation, a natural frequency corresponding to the at least one mass block 3 matches a frequency of noise generated by the first friction disc 11, the second friction disc 21 and the brake disc in a braking process.

In this embodiment, to maximize the reduction of braking noise by arranging the at least one mass block 3 on the first friction disc 11 and the second friction disc 21, the frequencies of the at least one mass block 3 arranged on the first friction disc 11 and the second friction disc 21 need to match the frequency of noise generated by the first friction disc 11, the second friction disc 21 and the brake disc in the braking process. In other words, the at least one mass block 3 needs to have an appropriate mass determined based on the frequency of noise generated by the first friction disc 11, the second friction disc 21 and the brake disc in the braking process. By changing the mass of the at least one mass block 3, there is a relatively large difference between the natural frequencies of the first friction disc 11 and the second friction disc 21 each provided with the at least one mass block 3 and the frequency of low-frequency noise.

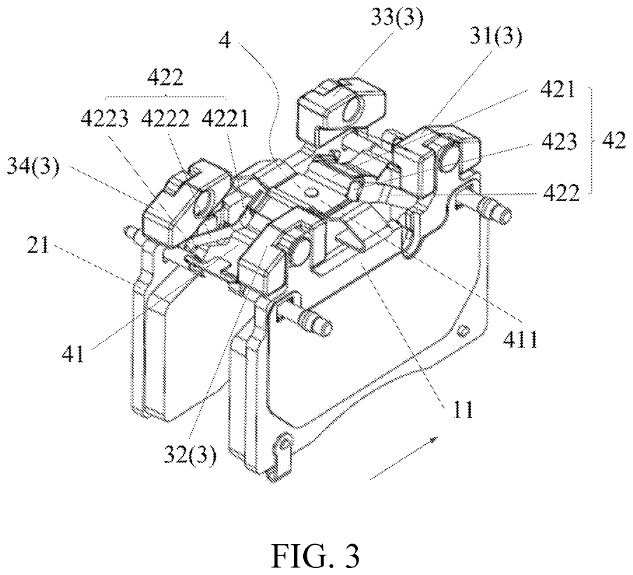

As shown in FIGS. 1 and 3, in this embodiment, to improve the reduction of the noise in the braking process by installing the at least one mass block 3 on the first friction disc 11 and the second friction disc 21, the first friction disc 11 is provided with a first mass block 31 and a second mass block 32, the second friction disc 21 is provided with a third mass block 33 and a fourth mass block 34, the first mass block 31 and the second mass block 32 are respectively arranged at two ends of the first friction disc 11 in a first direction, and the third mass block 33 and the fourth mass block 34 are respectively arranged at two ends of the second friction disc 21 in the first direction.

Since natural frequency of an object is closely related to mass and mass distribution of the object, in this embodiment, the first mass block 31 and the second mass block 32 are arranged at two ends of the first friction disc 11, while the third mass block 33 and the fourth mass block 34 are arranged at two ends of the second friction disc 21, so that the first mass block 31 and the second mass block 32 are arranged symmetrically with the third mass block 33 and the fourth mass block 34 along a plane of connection between the first caliper body 1 and the second caliper body 2 respectively. Thus, it can be easier to adjust the mass of the at least one mass block 3 in the process of adjusting the mass of the at least one mass block 3 to adjust the natural frequencies of the first friction disc 11 and the second friction disc 21 each provided with the mass blocks 3.

It should be noted that, in this embodiment, the first direction is a direction parallel to the bottom of the first friction disc 11 and parallel to a contact surface between the first friction disc 11 and the first caliper body 1, and is a direction shown by the arrow in FIG. 3.

As shown in FIG. 3, in a possible implementation, the first mass block 31 and the second mass block 32 are separately riveted to the first friction disc 11, and the third mass block 33 and the fourth mass block 34 are separately riveted to the second friction disc 21, to meet a requirement that the first mass block 31 and the second mass block 32 are separately fixedly connected to the first friction disc 11, and a requirement that the third mass block 33 and the fourth mass block 34 are separately fixedly connected to the second friction disc 21.

It can be understood that, although in this embodiment, a connection relationship between the first mass block 31 and the second mass block 32 and the first friction disc 11 and a connection relationship between the third mass block 33 and the fourth mass block 34 and the second friction disc 21 are described by taking separate riveting of the first mass block 31 and the second mass block 32 to the first friction disc 11 and separate riveting of the third mass block 33 and the fourth mass block 34 to the second friction disc 21 as examples, the connection relationship between the first mass block 31 and the second mass block 32 and the first friction disc 11 and the connection relationship between the third mass block 33 and the fourth mass block 34 and the second friction disc 21 in this embodiment are not limited thereto, provided that the connection relationships can meet assembly requirements that the first mass block 31 and the second mass block 32 are fixedly installed on the first friction disc 11 and that the third mass block 33 and the fourth mass block 34 are fixedly installed on the second friction disc 21. For example, the first mass block 31 and the second mass block 32 are separately bolted to the first friction disc 11, and the third mass block 33 and the fourth mass block 34 are separately bolted to the second friction disc 21. For another example, the first mass block 31 and the second mass block 32 are separately welded to the first friction disc 11, and the third mass block 33 and the fourth mass block 34 are separately welded to the second friction disc 21.

As shown in FIGS. 1 and 3, in a possible implementation, the brake further comprises an active return device 4, wherein the active return device 4 comprises a fixedly-arranged active return device body 41 and two return springs 42 symmetrically attached on the active return device body 41, and two ends of each return spring 42 abut against the first friction disc 11 and the second friction disc 21 respectively.

Through the foregoing arrangement, in the brake for a vehicle according to the disclosure, the structure of the active return device 4 arranged in the brake comprises the active return device body 41 and the two return springs 42 symmetrically attached on the active return device body 41, so that the two return springs 42 are symmetrically arranged between the first friction disc 11 and the second friction disc 21, so as to solve the problem that in an existing brake for a vehicle, return springs are usually arranged at middle positions of friction discs, so the friction discs may rotate with respect to the contacting edge between the return springs and the friction discs, resulting in eccentric wear and a relatively low reduction in drag torque.

As shown in FIGS. 1 and 3, for the active return device 4 to keep providing return spring force at the same level to the first friction disc 11 and the second friction disc 21 at any point during the service life of the first friction disc 11, the second friction disc 21 and the brake disc, in this embodiment, each of the return springs 42 comprises a return beam 421 and two resilient pieces 422 symmetrically arranged on two sides of the return beam 421, and the return beam 421 is fixedly connected to the active return device body 41.

In this embodiment, the two resilient pieces 422 are symmetrically arranged on the two sides of the return beam 421, so that in the braking process, the resilient piece 422 arranged on the either side of the return beam 421 is subjected to the same compressive force from the first friction disc 11 or the second friction disc 21. Therefore, elastic deformation of the resilient piece 422 arranged on the either side of the return beam 421 is the same, so that the active return device 4 can provide return spring force at the same level to the first friction disc 11 and the second friction disc 21 at any point during the service life of the first friction disc 11, the second friction disc 21 and the brake disc, thus a gap generated between the brake disc and the first friction disc 11 and a gap generated between the brake disc and the second friction disc 21 are also roughly the same, thereby reducing the drag torque in the braking process, improving mileage range of the vehicle, and prolonging lifespans of the brake disc, the first friction disc 11 and the second friction disc 21.

As shown in FIG. 3, to further improve the return effect of the active return device 4 and maintain a same feeling on a brake pedal for a user during the service life of the brake, in this embodiment, each of the two resilient pieces 422 comprises a first bent portion 4221, a second bent portion 4222 and a third bent portion 4223 which are connected in sequence, the first bent portion 4221 is connected to the return beam 421, and the third bent portion 4223 abuts against the first friction disc 11 or the second friction disc 21.

Through the foregoing arrangement, each resilient piece 422 abuts against the first friction disc 11 or the second friction disc 21 through the third bent portion 4223. This reduces a contact area between the return spring 42 and the first friction disc 11 or the second friction disc 21, so as to improve the return effect of the active return device 4.

Through the foregoing arrangement, in the braking process, the two resilient pieces 422 arranged on the two sides of the return beam 421 are compressed by the first friction disc 11 and the second friction disc 21 respectively, and with repeated braking, the two resilient pieces 422 arranged on the two sides of the return beam 421 are elastically deformed, so that after the braking is stopped, resilience force applied by each resilient piece 422 to the first friction disc 11 or the second friction disc 21 gradually decreases with the number of times of repeated braking, and thus the gap between the brake disc and the first friction disc 11 after being bounced back by the resilience force and the gap between the brake disc and the second friction disc 21 after being bounced back by the resilience force gradually become smaller. In addition, with repeated braking, the first friction disc 11 and the second friction disc 21 are constantly worn, and thus thicknesses of the first friction disc 11 and the second friction disc 21 are also reduced accordingly. Assuming that the same resilience force is always applied to the first friction disc 11 and the second friction disc 21 during the service life of the active return device 4, positions of the first friction disc 11 and the second friction disc 21 after being bounced back by the resilience force will always remain unchanged, so that with the constant wear of the first friction disc 11 and the second friction disc 21 in the repeated braking process, the gap between the brake disc and the first friction disc 11 after being returned to its inoperative position and the gap between the brake disc and the second friction disc 21 after being returned to its inoperative position gradually become larger. Therefore, as the two resilient pieces 422 arranged on the two sides of the return beam 421 are elastically deformed with repeated braking, the gap between the brake disc and the first friction disc 11 and the gap between the brake disc and the second friction disc 21 gradually become smaller, which counteracts a situation in which the gap between the brake disc and the first friction disc 11 and the gap between the brake disc and the second friction disc 21 after being returned to their respective inoperative positions gradually become larger with the constant wear of the first friction disc 11 and the second friction disc 21 in the repeated braking process. Therefore, the gap between the brake disc and the first friction disc 11 and the gap between the brake disc and the second friction disc 21 after being respectively bounced back by the resilience force are kept consistent during the service life of the active return device 4. This avoids a slow braking response caused when the gap between the brake disc and the first friction disc 11 and the gap between the brake disc and the second friction disc 21 become increasingly larger with the constant wear of the first friction disc 11 and the second friction disc 21 during repeated braking.

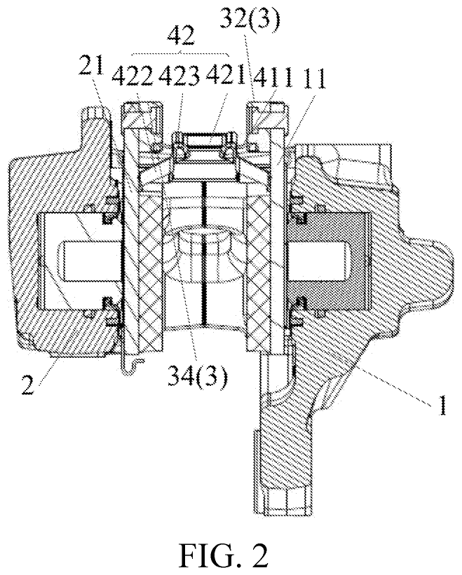

As shown in FIGS. 2 and 3, to further improve the return effect of the active return device 4 on the first friction disc 11 and the second friction disc 21, in this embodiment, an arc-shaped bend 423 is further arranged between the return beam 421 and each resilient piece 422.

In this embodiment, the arc-shaped bend 423 is arranged between the return beam 421 and each resilient piece 422, so that after the braking is stopped, the arc-shaped bend 423 can provide greater resilience force to the first friction disc 11 and the second friction disc 21, so as to improve the resilience effect of the active return device 4 on the first friction disc 11 and the second friction disc 21.

As shown in FIGS. 1 and 3, in this embodiment, to further improve the universal applicability of the active return device 4 in this embodiment, the return spring 42 is detachably connected to the active return device body 41, so that the universal applicability of the active return device 4 in this embodiment can be improved by independently designing the return spring 42 to match brake discs with different thicknesses.

In addition, as shown in FIGS. 1 and 3, to prevent the first friction disc 11 and the second friction disc 21 from jumping upwards in the braking and returning process, in this embodiment, the active return device body 41 is further provided with a bridge-shaped structure 411, and the bridge-shaped structure 411 is fixedly connected to the active return device body 41.

Through the foregoing arrangement, the bridge-shaped structure 411 arranged on the active return device body 41 can better limit the first friction disc 11 and the second friction disc 21, so as to prevent the first friction disc 11 and the second friction disc 21 from jumping upwards in the braking and returning process.

In conclusion, in the brake for a vehicle according to the disclosure, the first friction disc 11 and the second friction disc 21 are each provided with the at least one mass block 3, and natural frequencies of the first friction disc 11 and the second friction disc 21 each provided with the at least one mass block 3 are adjusted by tuning properties such as mass, density and volume of the at least one mass block 3, so that there is a relatively large difference between the natural frequencies of the first friction disc 11 and the second friction disc 21 each provided with the at least one mass block 3 and a frequency of low-frequency noise, so as to quickly reduce low-frequency operating noise of the brake, thereby fundamentally eliminating braking noise, and then solving the problem that existing brakes for a vehicle usually cannot overcome low-frequency stubborn noise generated by a caliper structure in the brake in a braking process. In addition, the brake according to the disclosure further improves the comfort level of driving experience of a user, and solves the problem in the prior art that a development cycle is prolonged due to modification of a caliper structure and a mold during reduction of braking noise.

It should be noted that the foregoing implementations are only used to explain the principles of the disclosure, and are not intended to limit the scope of protection of the disclosure. Those skilled in the art can adjust the foregoing structures without departing from the principles of the disclosure, so that the disclosure is applicable to more specific application scenarios.

In addition, the disclosure further provides a vehicle. The vehicle is provided with a brake for a vehicle according to any one of the foregoing implementations.

In addition, it can be understood by those skilled in the art that, although some embodiments described herein comprise certain features included in other embodiments, instead of other features, combinations of the features of different embodiments mean to be within the scope of protection of the disclosure and form different embodiments. For example, in the claims of the disclosure, any one of the embodiments set forth thereby can be used in any combination.

Heretofore, the technical solutions of the disclosure have been described with reference to the preferred implementations shown in the accompanying drawings, however, those skilled in the art may readily understand that the scope of protection of the disclosure is obviously not limited to these specific implementations. Those skilled in the art can make equivalent changes or substitutions to the related technical features without departing from the principles of the disclosure, and all the technical solutions after the changes or the substitutions fall within the scope of protection of the disclosure.

What is claimed is:

1. A brake for a vehicle, comprising a first caliper body and a second caliper body, wherein the first caliper body and the second caliper body are provided with a first friction disc and a second friction disc respectively, a brake disc is arranged between the first friction disc and the second friction disc, and the first friction disc and the second friction disc are each further provided with at least one mass block.

2. The brake for a vehicle according to claim 1, wherein a natural frequency corresponding to the at least one mass block matches a frequency of noise generated by the first friction disc, the second friction disc and the brake disc in a braking process.

3. The brake for a vehicle according to claim 1, wherein the first friction disc is provided with a first mass block and a second mass block, the second friction disc is provided with a third mass block and a fourth mass block, the first mass block and the second mass block are respectively arranged at two ends of the first friction disc in a first direction, and the third mass block and the fourth mass block are respectively arranged at two ends of the second friction disc in the first direction.

4. The brake for a vehicle according to claim 3, wherein the first mass block and the second mass block are separately riveted or bolted or welded to the first friction disc, and the third mass block and the fourth mass block are separately riveted or bolted or welded to the second friction disc.

5. The brake for a vehicle according to claim 1, further comprising an active return device, wherein the active return device comprises a fixedly-arranged active return device body and two return springs symmetrically attached on the active return device body, and two ends of each of the two return springs abut against the first friction disc and the second friction disc respectively.

6. The brake for a vehicle according to claim 5, wherein the two return springs each comprises a return beam and two resilient pieces symmetrically arranged on two sides of the return beam, and the return beam is fixedly connected to the active return device body.

7. The brake for a vehicle according to claim 6, wherein the two resilient pieces each comprises a first bent portion, a second bent portion and a third bent portion which are connected in sequence, the first bent portion is connected to the return beam, and the third bent portion abuts against the first friction disc or the second friction disc.

8. The brake for a vehicle according to claim 7, wherein an arc-shaped bend is further arranged between the return beam and each resilient piece.

9. The brake for a vehicle according to claim 5, wherein the active return device body is further provided with a bridge-shaped structure, and the bridge-shaped structure is fixedly connected to the active return device body.

10. The brake for a vehicle according to claim 7, wherein the return spring is detachably connected to the active return device body.

11. A vehicle, comprising a brake for the vehicle, the brake comprising a first caliper body and a second caliper body, wherein the first caliper body and the second caliper body are provided with a first friction disc and a second friction disc respectively, a brake disc is arranged between the first friction disc and the second friction disc, and the first friction disc and the second friction disc are each further provided with at least one mass block.
